(19) United States
(12) Patent Application Publication
(10) Pub. No.: US 2007/0136083 A1
(43) Pub. Date: Jun. 14, 2007

(54) Vehicle payment system and method of using bidreturn communication link

(75) Inventors: Michael P. Simon, Hemet, CA (US); Franklin C. Simon, Hollywood, FL (US)

Correspondence Address: BUCHANAN, INGERSOLL & ROONEY PC, POST OFFICE BOX 1404, ALEXANDRIA, VA, 22313-1404, US

(73) Assignee: Payment Protection Systems

(21) Appl. No.: 11/350,934

(22) Filed: Feb. 10, 2006

Related U.S. Application Data
(60) Provisional application No. 60/651,516, filed on Feb. 10, 2005.

(51) Int. Cl. G06Q 99/00

(52) U.S. Cl. 705/1

(57) ABSTRACT

Provided is a method for disabling a motor vehicle when a user of the motor vehicle fails to complete a specific task, such as making a loan or lease payment. The method comprises first determining a payment due deadline and forwarding a signal on a two-way communication system a predetermined number of days prior to the due date to initiate a reminder system in the vehicle that the payment is coming due. A return signal is sent to the provider of the first signal that the first signal was received and the reminder system activated. Once it is determined that the due date has passed and payment has still not been made, another signal is sent which disables the vehicle. A return signal, if desired, can again be sent to the provider that the first signal for disabling the vehicle was safely received, and that the vehicle was disabled. A keypad is also provided in the system for entering an emergency code to enable the motor vehicle for a predetermined period of time whenever the vehicle has been disabled.

### RELATED APPLICATION

The present application claims priority to Provisional U.S. patent application No. 60/651,516, filed on Feb. 10, 2005, which is herein incorporated by reference in its entirety.

### BACKGROUND OF THE INVENTION

The present invention is related to systems and methods for disabling equipment in response to the failure of a user to perform a specific task. More particularly, the present invention is related to systems and methods that disable a vehicle in response to the failure of a user to make a loan or lease payment.

Typically, monthly payments to utility companies are made with very high reliability. This is partly due to the threat of service cut-off. For example, failure to pay a telephone bill will result in loss of telephone services. Thus, telephone bills are paid regularly because failure to do so has immediate and tangible results. Monthly payments on an automobile loan, for example, are not likely to be as regular. Although an automobile may be repossessed, the process is expensive and complex. Thus, the threat of repossession is less immediate than telephone service cut-off. To encourage reliable loan re-payments, it is desirable to have a “service” cut-off for equipment subject to the loan, such as an automobile.

Conventional systems to encourage reliable loan re-payments interrupt the ignition system of an automobile on a regular, timed interval. To re-enable the automobile, a user is required to return to a payment center, make a payment, and have an agent reset the interrupt mechanism for a renewed timed interval. The system can only be reset by an authorized agent as it requires a key held in escrow at the payment center. While such a system is effective in encouraging users to repay their loans in a timely fashion, it has extreme overhead considerations. For example, the system requires a user to travel to the payment center each payment period of the loan in order to re-enable the automobile. In addition, a user must arrive at the payment center during its customer service hours. Still further, a user may have to wait to receive the attention of the first available agent at the payment center. As these problems pose considerable inconvenience, it is further desirable for a system and method that can reset the timed interval without the need for the user to travel to the payment center.

One solution to these problems is described in U.S. Pat. No. 6,195,648 entitled “Loan Repay Enforcement System” which is incorporated in its entirety herein by reference. Described is a system and method for disabling equipment if a payment is not timely made. Specifically, a control module associated with the equipment stores a plurality of codes. In order to prevent disablement of the equipment, a code which corresponds to one of the stored plurality of codes must be entered prior to the expiration of a payment period. In order to receive a code, timely payment must be received and logged in a payment center. The entering of payment codes at times can be can be cumbersome. There are times when simply sending a communication equivalent to a code that disables the vehicle would be preferable, provided the system could be effective and safe.

In U.S. Pat. Nos. 6,026,922 and 5,819,869, there is disclosed a method and apparatus in which a pocket pager or other data transmission device of conventional design is used to disable remotely the operation of an electrical device or the starting sequence of a motor vehicle. More precisely, the radio device is connected to pull open a latching relay in the power circuit, like the ignition circuit of the vehicle or the electric power connection and once the pager receives its code all further re-starts are disabled. The vehicle or device thus remains inoperative, and the relay then remains latched open until reset by a concealed push-to-close momentary switch. Alternatively, a second code combination may be transmitted to reset the relay. In application, the signal to the pager will first be preceded by a telephone call from the leasing, financing or rental agency to a telephone number designated by the user, and if the response to this phone call is unsatisfactory only then is the pager disabling sequence effected. In this manner the user is first warned, and then the vehicle or article is disabled only upon such a warning.

The convenience effectiveness and safety of such a pager system can still be improved. The provision of a system which is safe and convenient for the user as well as the provider would be of value to the industry.

### SUMMARY OF THE INVENTION

Accordingly, the present invention provides a method for disabling a motor vehicle when a user of the motor vehicle fails to complete a specific task, such as making a loan or lease payment, which method is more convenient effective and safer for the user and provider of the disabling signal. The method comprises first determining a payment due deadline and forwarding a signal on a two way communications system a predetermined number of days prior to the due date to initiate a reminder system in the vehicle that the payment is coming due. A return signal is sent to the provider of the first signal that the first signal was received and the reminder system activated. The reminder system can be auditory, visual or both. Once it is determined that the due date has passed and payment has still not been made, a signal is sent which disables the vehicle. A return signal, if desired, can again be sent to the provider that the first signal for disabling the vehicle was safely received. For purposes of safety, a key pad is also provided in the system for entering an emergency code to enable the motor vehicle for a predetermined period of time. This would allow enablement by the user should the vehicle be disabled in an unfavorable location.

Among other factors, it has been found that by employing a two way communications system so return signals can be sent notifying the sender that the original signal was received and that the reminder system was activated is valuable and can avoid many difficult situations. Confirmation of the reminder, and/or disablement renders the entire process more effective. The user receives a reminder to avoid disablement, while the provider knows the first signal was received and that the dictated action was taken. Moreover, the further provision of the keypad allows the user to remove himself from a difficult situation should disablement of the vehicle occur in an unfortunate location. The present system employing the reminder and keypad functions provides one with a more convenient and safer system for encouraging payment of a loan or lease payment.

In a preferred embodiment, a disabling module in communication with a control module operates to disable or partially disable equipment in response to the failure of a user to complete a specific task, such as make a loan or lease payment. When a user makes a payment on an outstanding loan or lease, usually a loan related to specific equipment, such as a motorized vehicle, a control module is notified of the payment by means of a first signal from a two-way paging system, cell system or satellite communications system. The control module causes the equipment to be enabled or disabled in accordance with payment receipt. A return signal is then sent in order to notify the provider of the first signal that the first signal was properly received.

In accordance with another preferred embodiment of the present invention, the disabling module initiated by the signal of the two way communications system to disable the vehicle, also includes a vehicle location system which operates to provide a location of a vehicle if a payment due date associated with the vehicle has passed and a payment has not been received for the vehicle. The vehicle location system operates to provide the vehicle's location to a service agency. The service agency can then locate and repossess the vehicle. The service agency can be a lender or other party having a security interest in the vehicle. Alternatively, the service agency can have a contract with a party who has an interest in the vehicle to locate and repossess vehicles for which payments are delinquent. Additionally, the vehicle location system can be activated if it is detected that the vehicle is being tampered with. The location of the vehicle can be determined using global positioning satellites or by triangulation using base stations in mobile radio systems.

### BRIEF DESCRIPTION OF THE FIGURES OF THE DRAWING

FIG. 1 illustrates a block diagram of a basic apparatus involving the disabling features of the present invention.

FIG. 2 illustrates a vehicle with a vehicle disablement device in a location systems in accordance with exemplary embodiments of the present invention.

FIG. 3 illustrates the details of the location system in accordance with exemplary embodiments of the present invention.

### DETAILED DESCRIPTION OF THE PREFERRED EMBODIMENTS

The present invention provides an efficient, effective, convenient and safe method for disabling a motor vehicle when the user of the motor vehicle fails to complete a specific task such as making a loan or lease payment. The combination of a reminder system and a keypad function for allowing the temporary enablement of a disabled vehicle permits convenience, safety and effectiveness for the overall system, more so than has heretofore been offered. Moreover, the use of a two way communications system to disable and/or enable a vehicle, or initiate the reminder system, allows convenience and effectiveness due to the conformation it can provide.

The method and system of the present invention involves a two way communication system. The communication is between the provider of a first signal to the vehicle, which signal will disable (or enable) the vehicle. The provider can be a service agency such as a lender or other party having a security interest in the vehicle. The provider can also be a contracted party who is monitoring the payments to be made. The communication systems are two way paging, cell or satellite communications systems. Thus, the signals can be sent by way of a paging tower, a cell phone tower, or via satellite communication, e.g. satellite RF communications.

The first step in the method is to determine a payment due deadline. A signal can be sent to disable the vehicle once the payment due deadline has past. However, it is preferred that a signal be sent by way of the two way communications system a predetermined number of days prior to the due date to initiate a reminder system in the vehicle. This signal can be sent automatically via a web based system or other monitoring system, or can be sent by the provider of the first signal. The reminder system in the vehicle can be on a key pad or other display system installed in the vehicle, which can receive the signal and initiate a program of flashing lights or sounds to remind the user of the vehicle that a payment deadline is approaching.

As noted, the disablement device or system can include the reminder system comprised of a plurality of lights, e.g., light emitting diodes, to indicate if the end of a payment period is upcoming. For example, a green light would indicate that no payment is due, a yellow light would indicate that a payment is due shortly, and a red light would indicate that a payment is due immediately or the equipment will be disabled. Further, the lights can blink at an increasing frequency the closer in time it is to a payment due deadline. In addition to the use of lights to indicate whether a payment is upcoming or due, an audible beep or other sound can be used to indicate such. For example, a single beep can be used to indicate that a payment is upcoming and a constant beep can indicate that a payment is past due. Also, flashing numbers of 4, 3 2 or 1 can be used to indicate the number of days until the payment due deadline. The use of such a reminder system will effectively reduce the number of delinquencies and serve the effectiveness of the entire system, and more often save the user from the unfortunate incident of having the vehicle disabled.

By using a two way communication system, a signal can be returned to the provider from the vehicle confirming that in fact the first signal sent to the vehicle was received, and that the reminder system was properly initiated. The use of a microprocessor or computer can initiate such a return signal. The confirmation that in fact a signal was received and that the reminder system was initiated is valuable to the provider in negotiating the relationship with the user. Once the payment due deadline does pass, however, a signal will be sent either automatically, or initiated by the provider, by means of the two way communication system to the vehicle in order to disable the vehicle.

Once the payment due deadline has passed, a signal is then sent to disable the vehicle. The signal can be sent to a control module which then instructs a disabling module to disable the vehicle. The signal can be automatically sent, as discussed previously, or initiated by the provider of the signal. Once the signal has been received, and/or the vehicle has been disabled, a confirmation return signal can be sent to the provider in order to confirm that the signal was received and the vehicle disabled.

The system of the present invention also provides a keypad connected to the control module or disabling/enabling module, and in the vehicle which acts as an entry point for an emergency code, when necessary. The user of the vehicle would be provided an emergency code which would be inputted through the keypad in order to enable the motor vehicle for a predetermined period of time. The period of time can be, for example, a 24 hour period of time, or something shorter, such as 4 hours. The provision of the keypad emergency function provides safety to the user of the vehicle so that the user is not left in an unfavorable position. For example, if a communication is sent to disable the vehicle and the vehicle receives a signal while driving, but leaves the coverage area and is disabled outside of the coverage area, then there is no way to enable the vehicle through further wireless communication. The keypad is a solution to this problem, as an emergency code can be manually entered through the keypad that would enable the car to start. This can be used in the case of emergencies or if the customer wishes to get to the payment center to enter a payment.

The term “vehicle” is intended to include any vehicle with an ignition system. This would include cars, trucks, tractors, cranes, boats, snowmobiles, motorcycles, recreational vehicles, etc.

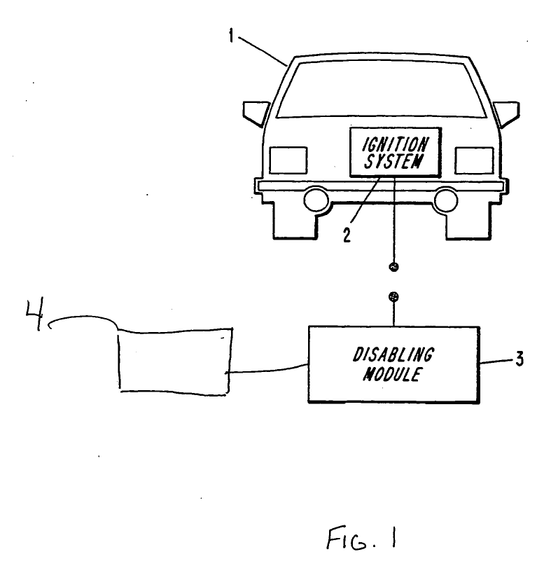

In an exemplary embodiment of the present invention, as shown in FIG. 1 of the drawing, the disabling module 3, includes an ignition interruption circuit that is coupled to ignition wires in an ignition system 2 leading from a standard ignition keyswitch of an automobile 1. In one exemplary embodiment, the disabling module 3 includes a circuit breaking switch. Arranged serially, either the disabling module 3 or the keyswitch will operate to cause an open circuit in the ignition wires, rendering the ignition of the automobile disabled. The disabling module 3 is in further communication with the control module 4. The control module 4 operates the disabling module 3 by sending commands to direct the disabling module 3 to take either of two alternative states.

A “disabled” state corresponds to an “open” ignition circuit while an “enabled” state corresponds to a “closed” ignition circuit. The control module 4 causes the disabling module 3 to switch between these two states. The signal received by the control module, and sent by the provider, can dictate in which state the circuit should be.

As used herein, the terms “disable” or “disabling” are intended to encompass both total and partial disablement. In exemplary embodiments of the present invention, the disabling module can disable a critical component or system of the equipment. For example, in an automobile, a critical component or system can be the brakes, the fuel pump, and/or the ignition circuit. Additionally or alternatively, the disabling module can partially disable the equipment by altering the operation of the equipment so as to provide a significant inconvenience to the user. For example, in an automobile, the disabling module can prevent the automobile from exceeding a predetermined speed limit such as 5-15 miles per hour and/or limit the fuel supply to the engine. Additionally or alternatively, the disabling module can cause the steering wheel to lock, can move the driver's seat to an undrivable position, can disable power steering, can disable the air conditioner, and/or can disable the radio and other accessories in the automobile. The disabling module can also cause the starter to not function and therefore not allow the car to start.

In an alternative embodiment of the present invention, the disabling module 3 can disable or partially disable the automobile by, for example, stopping the flow of fuel supplied to the engine, gradually reducing the amount of fuel supplied to the engine (if the automobile is moving), engaging the brakes or parking brake of the automobile, gradually applying the brakes of the automobile (if the automobile is moving), and/or opening the ignition circuit loop to simulate the removal of the ignition key. Also, a pager circuit can be connected to pull open a latching relay in the starting signal of the motor vehicle. Most preferably, however, the vehicle is disabled generally by disabling a system which supports causing ignition in an engine of the vehicle, which system includes only components not dedicated to directly causing a spark to initiate combustion. This would include, for example, precluding the starter from functioning or the fuel pump from functioning.

One will appreciate that in rare cases of emergency, provision for override may be useful. For example, if an automobile is disabled for lack of timely payment, then a special code to be used only in case of an emergency may temporarily re-enable the automobile. The use of a keypad in accordance with the present invention, as described above, allows this to be possible. Thus, a person in dire need of medical help may be transported with an otherwise disabled automobile when the emergency code is employed. By agreement, one can be charged heavy fines for misuse of emergency codes. In addition, the number of emergency code uses can be limited to a fixed amount within a given time period, for example, two or three times in a month. In this way, non-emergency use is highly discouraged. The system is made secure against use outside designed limits while still accommodating occasional emergencies.

FIG. 2 illustrates a vehicle with a vehicle disablement device and a location system in accordance with exemplary embodiments of the present invention. As illustrated in FIG. 2, a vehicle 110 which is equipped with a vehicle disablement device 120 can also include a location system 130. In accordance with exemplary embodiments of the present invention, if the vehicle becomes disabled or if it is detected that vehicle disablement device 120 has been tampered with, location system 130 will be activated to provide the location of the vehicle.

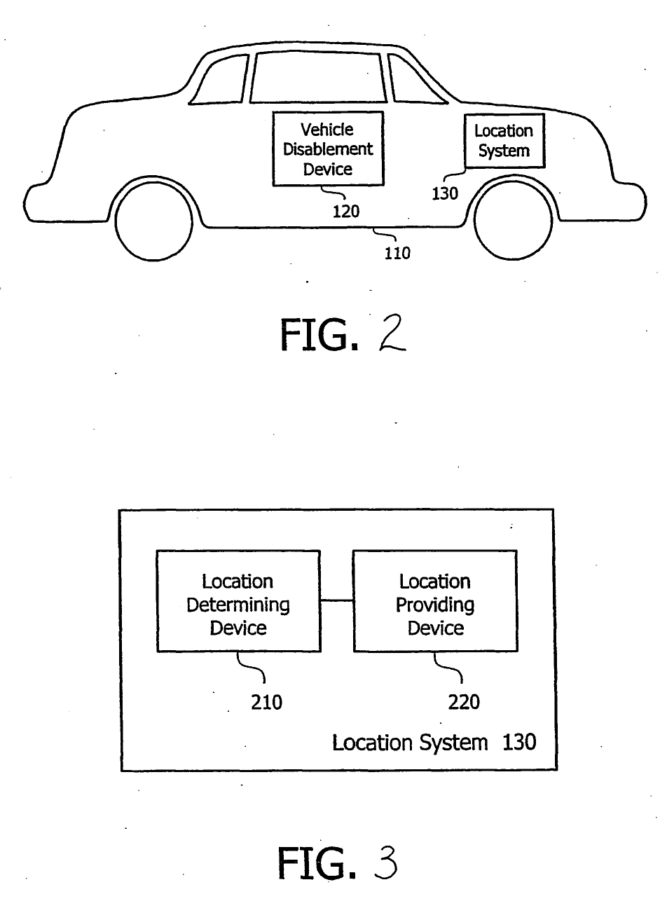

FIG. 3 illustrates the details of a location system in accordance with exemplary embodiments of the present invention. In accordance with exemplary embodiments of the present invention, location system 130 includes a location determining device 210 and a location providing device 220. Upon activation of location system 130, location determining device 210 will be activated to determine the current location of the vehicle. In accordance with exemplary embodiments of the present invention, location determining device 210 is a global positioning satellite (GPS) receiver. Alternatively, the location of the vehicle can be determined by triangulation based upon signals from three base stations in a mobile radio communication system, or any other location determining technique.

After the location of the vehicle has been determined, location determining device 210 will provide the location providing device 220 with the current location of the vehicle. Location providing device 220 can then provide the current location of the vehicle to a service agency responsible for ensuring payments are made on the vehicle. In accordance with exemplary embodiments of the present invention, location providing device 220 can be a mobile telephone. Although the location determining device 210 and the location providing device 220 are illustrated in FIG. 3 as separate components, it should be recognized that these can be designed in a single component, e.g., a GPS enabled mobile telephone.

Also, when a GPS system is employed, one can combine the wireless two way communication system of the present invention with the GPS chip set. The GPS chip set can be used to confirm the date and time for calculating when the reminder system should disable the vehicle. By using the GPS chip set, the need for a separate clock chip would be avoided. Use of the GPS time and date to calculate/determine certain shut off decisions would be of great value.

Although the present invention has been described in considerable detail with clear and concise language an with reference to certain preferred versions thereof including the best mode anticipated by the inventor, other versions are possible. Therefore, the spirit and scope of the invention should not be limited by the description of the preferred versions contained herein, but rather by the claims appended hereto.

What is claimed is:

1. A method of disabling a motor vehicle in response to payments not being timely made, comprising the steps of:
a. determining a payment due deadline;
b. forwarding a signal to the vehicle by way of a two-way communication system which initiates an audible or visible warning within the vehicle;
c. upon the payment due deadline passing, sending an additional signal to the vehicle in order to disable the vehicle;
d. providing a return signal to confirm that the first signal was received and the vehicle disabled;
e. providing a keypad for entry of an emergency code which would enable the motor vehicle for a predetermined period of time whenever the vehicle is disabled.

2. The method of claim 1, wherein the predetermined period of time for which the emergency code enables a motor vehicle is twenty-four hours or less.

3. The method of claim 1, wherein a vehicle location device is initiated once the vehicle is disabled.

4. The method of claim 1, wherein the two-way communication system is a pager system.

5. The method of claim 1, wherein the two-way communication system is a cellular telephone system.

6. The method of claim 1, wherein the two way communication system is comprised of a satellite communication system.

7. A system for disabling a motor vehicle which comprises:
a two communication system linked between a first provider of a signal and a motor vehicle,
a means for determining a payment due deadline,
means for forwarding a signal from the first provider to the motor vehicle when the payment due deadline is passed in order to disable the vehicle,
means for returning a signal to the provider from the motor vehicle indicating that the disabling signal was received and the vehicle disabled, and
a keypad connected to a control module which allows one to input a code which would initiate enablement of the motor vehicle by the control module for a predetermined period of time.

8. The system of claim 7, wherein the predetermined period of time for which the emergency code enables a motor vehicle is 24 hours or less.

9. The system of claim 7, wherein the two-way communication system is comprised of a cellular telephone link, a pager system, or a satellite communication system.

10. The system of claim 7, further comprising a vehicle location device.

11. A method for disabling a motor vehicle in response to payments not being timely made, comprising the steps of:
determining whether a payment due deadline has passed,
sending a signal from a provider of the signal to a motor vehicle for disabling the vehicle,
returning a signal from the motor vehicle to the provider of the first signal indicating that the first signal was received and that the vehicle was disabled, and
providing a keypad for entering an emergency code which would initiate enablement of the motor vehicle for a predetermined period of time when the vehicle is disabled.

12. The method of claim 11, wherein a location providing device provides a signal as to the location of the motor vehicle when the motor vehicle is disabled.

13. The method of claim 11, wherein the predetermined period of time for which the emergency code enables the motor vehicle is twenty-four hours or less.

14. The method of claim 11, wherein the disablement of the vehicle involves disabling a system which supports causing ignition in an engine of the vehicle, which system includes only components not dedicated to directly causing a spark to initiate combustion.

15. The method of claim 11, wherein a two-way communication system is comprised of a cellular telephone system, a pager system or a satellite communication system.
